(19) United States
(12) Patent Application Publication
(10) Pub. No.: US 2009/0135282 A1
(43) Pub. Date: May 28, 2009

(54) Visible imaging device with a colour filter

(75) Inventor: Serge Gidon, La Murette (FR)

Correspondence Address: Nixon Peabody LLP, 200 Page Mill Road, Palo Alto, CA, 94306, US

(73) Assignee: COMMISSARIAT A L'ENERGIE ATOMIQUE, Paris (FR)

(21) Appl. No.: 12/291,914

(22) Filed: Nov. 14, 2008

(30) Foreign Application Priority Data
Nov. 27, 2007 (FR) 07 59346

(51) Int. Cl. H04N 5/335

(52) U.S. Cl. 348/273; 348/E05.091

(57) ABSTRACT

A visible imaging device with a colour filter, including:
main optics (10) equipped with a pupil,
a sensor (13) forming a sensitive pixel array,
a circuit for addressing said pixels,
a microlens array (14) producing the optical conjugation between the pupil of the main optics (10) and a group of pixels of the sensor,
a colour filter (30, 40),
in which the colour filter (30, 40) is arranged in the vicinity of the pupil of the main optics.

### CROSS REFERENCE TO RELATED APPLICATIONS OR PRIORITY CLAIM

This application claims priority to French Patent Application No. 07 59346, filed Nov. 27, 2007.

### DESCRIPTION

1. Technical Field

The invention relates to a visible imaging device with a colour filter.

2. Prior Art

The field of visible imaging devices is growing rapidly. Thus, numerous multi-use portable telephones with a photographic apparatus, i.e. a camera, function are currently being placed on the market. This is a very competitive field, which requires production costs to be reduced. Moreover, imaging devices are becoming smaller and smaller, as production processes make it possible to produce more sensors per silicon wafer. Increasing numbers of pixels (or image elements) are thus provided for each sensor. A pixel corresponds to a basic pattern including the sensitive zone and the spaces reserved for interconnections or electronic circuits. Imaging devices with more than 3 million pixels (2000×1500 pixels) are normally available. The dimension of a pixel is then on the order of 2 μm, and is expected to reach 1 μm.

The production of a portable telephone image sensor, as shown in FIG. 1, is based on the assembly of main optics 10 with a short focal length, equipped with a pupil, for example a focal length of several millimetres, as described in the document referenced [1] at the end of the description, forming the image 12 of a scene 11 on the plane of the image sensor 13, which is formed by a pixel array, in which each pixel corresponds to a sensitive sub-element of the sensor. These main optics 10 can integrate an infrared (IR) filter, not shown in the figure, which protects the image sensor, which is sensitive to infrared, from glare by radiation that does not correspond to what is perceived by the human eye.

Such a sensor is made of microelectronics, enabling the juxtaposition of basic pixels, which are read in rotation by an integrated addressing circuit, as described in the document referenced [2]. This circuit comprises transistors made of silicon (“front end”), electrical connections necessary for the interconnections and an addressing function usually placed above the silicon (“back end”). The proximity of these metal conductors to the sensitive zones of the sensor leads to diffraction phenomena that are limited by means of a microlens array 14, in which the microlenses serve to (re) focus the rays from the main optics 10 to the plane of the sensor 13. These microlenses 14 produce an optical conjugation between the pupil of the main optics 10 and the detection zone of each pixel. The number of microlenses 14 is the same as the number of sensitive pixels, with a pitch substantially equal to that of the pixels, which pitch can nevertheless be adapted so as to take into account the inclination of the rays at the edge of field. The digital opening of the main optics 10, which is theoretically associated with the pitch of the pixels (or that of the microlenses) and their focal length, typically on the order of 0.3.

The microlens array 14 is made in an integrated manner on the sensor, so as to ensure the necessary alignments and so as to have microlenses with the shortest possible focal distance in order to increase their digital opening (diameter/focal length) in order to limit diffraction effects. In practice, this focal distance is imposed by the technological choices and the thickness of the metallizations, which are typically 2 μm.

The pixels can be associated, for example, in blocks of four, and provided with a tricolour colour filter pattern (RGB or Red-Green-Blue) 20 so as to perceive the colours, with these patterns selecting complementary fields of the visible spectrum. Such a structure with a periodic colour filter, the best known being called the “Bayer filter”, is generally integrated as close as possible to the pixels on or under the microlenses, as shown in FIG. 2A. It is then produced by successive depositions of organic coloured materials defined by all known microelectronics processes, typically by photolithographic etching.

FIG. 2B shows such a colour filter structure 20 of the “Bayer filter” type, with three colours: red 22, green 23 and blue 24. FIG. 2C shows the filtered images 21 of the pupil of the main optics 10 obtained in the plane of the sensor 13.

The reduction of the pixel size presents an optical problem and an integration problem:

The optical problem is inherent to the diffraction phenomenon that appears when the size of the optical elements approaches that of the wavelength. The light rays can no longer be considered to be propagated in a straight line. It is necessary to take into account the undulating nature of light, which induces a convolution of the images by diffraction. Thus, the microlenses, due to the reduction in their size, no longer form actual images of the pupil of the main optics on the plane of the sensor, but instead form light spots with diffraction lobes that cannot be superimposed precisely at the detection zones.

The integration problem lies in the difficulty of producing a “Bayer filter” due to the need to produce increasingly precise lithographic patterns in order to juxtapose the various materials constituting said filter. Thus, such filters can be produced by using inkjet technology, described in the document referenced [3]. This document indeed describes a process for producing a colour filter comprising ink films in openings contained and delimited by beds formed on a substrate comprising a first step for forming a metal film on the substrate; a second step for forming the beds by forming a photosensitive organic thin film on the metal film; and a third step for forming the ink films by filling the ink openings.

The invention is intended to overcome the disadvantages of the known prior art devices by proposing a visible imaging device with a colour filter that makes it possible to dissociate the problem of producing the colour filter from the problem of producing the sensor by avoiding having the colour filter on each group of pixels and by maintaining a reasonable microlens size in order to limit the diffraction phenomena.

### DESCRIPTION OF THE INVENTION

This invention relates to a visible imaging device with a colour filter, including:

main optics equipped with a pupil,

a sensor forming a sensitive pixel array,

a circuit for addressing said pixels,

a microlens array producing the optical conjugation between the pupil of the main optics and a group of pixels of the sensor,

a colour filter,

characterised in that the colour filter is arranged in the vicinity of the pupil of the main optics and in that the pitch of the microlenses is twice that of the pixels.

Advantageously, in an alternative embodiment, the colour filter can then have a structure with twice the pitch of the structure of a filter with four zones.

Advantageously, in the sensor, the metallizations pass around groups of four pixels.

When the pupil has a circular shape, the sensitive zones of the sensor advantageously have the shape of disk quadrants.

Advantageously, the main optics include an infrared filter and/or an OLPF (optical low pass filter) on which the colour filter structure is produced.

Advantageously, the colour filter can also be arranged on a curved surface of the main optics.

### BRIEF DESCRIPTION OF THE DRAWINGS

FIG. 1 shows the principle of a visible imaging device with refocussing microlenses of the prior art.

FIGS. 2A to 2C show a visible imaging device with a colour filter of the prior art. FIGS. 3A to 3C show the visible imaging device of the invention with a simple colour filter structure.

FIGS. 4A to 4C show the visible imaging device of the invention with an oversampling of the colour filter at the input.

FIGS. 5A to 5C show the visible imaging device of the invention with an optimization of the illuminated zone, using microlenses with a short focal length.

FIG. 6 shows the sensitive zones of the sensor of the device of the invention, taking into account a pupil of the main optics with a circular shape.

### DETAILED DESCRIPTION OF SPECIFIC EMBODIMENTS

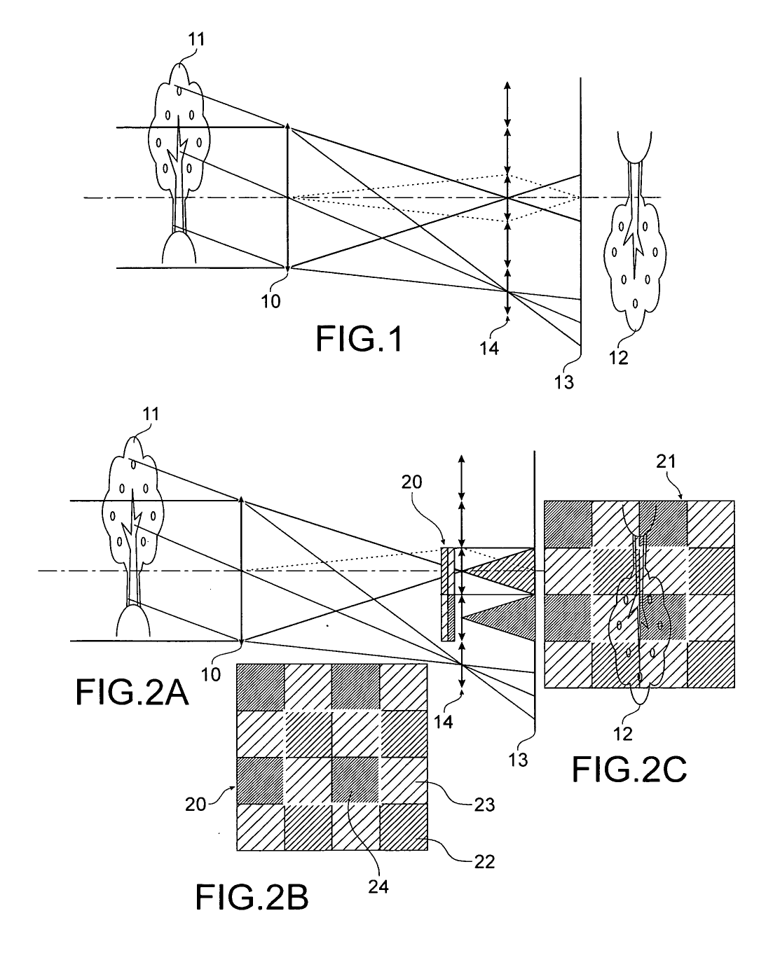

Below, the same references are used for the elements already described in the imaging devices of the prior art as shown in FIGS. 1 and 2. Thus, references 22, 23 and 24 are used for the colours red, green and blue.

In the visible imaging device of the invention, shown in FIG. 3A, the colour filter 30 is arranged in the vicinity of the pupil of the main optics 10. The microlens array 14 can thus advantageously have twice the pitch of the pixel array of the sensor 13. The microlenses 14, which form the image 31 of the pupil of the main optics 10 in the plane of the sensor 13, produce as many sub-images of the colour filter on this plane. These microlenses thus produce the optical conjugation between the pupil of the main optics and a group of pixels of the sensor 13. The double pitch is chosen by taking into account patterns of the colour filter 30. The structure of this colour filter 30 can, for example, be the basic structure of a Bayer filter with four zones.

FIG. 3B shows such a colour filter structure 30.

FIG. 3C shows the filtered image 31 of the pupil of the main optics 10 in the plane of the sensor 13.

The device of the invention is advantageous:

for design reasons: having a pitch twice that of the pixels, for microlenses, makes it possible to double the resolution without increasing the diffraction effects inherent to the size of the microlenses, and

for practical reasons: the microlenses 14 are larger, and therefore, in principle, easier to control; moreover, the colour filter 30, which needs only to be attached in the vicinity of the pupil of the main optics 10, has a simple structure.

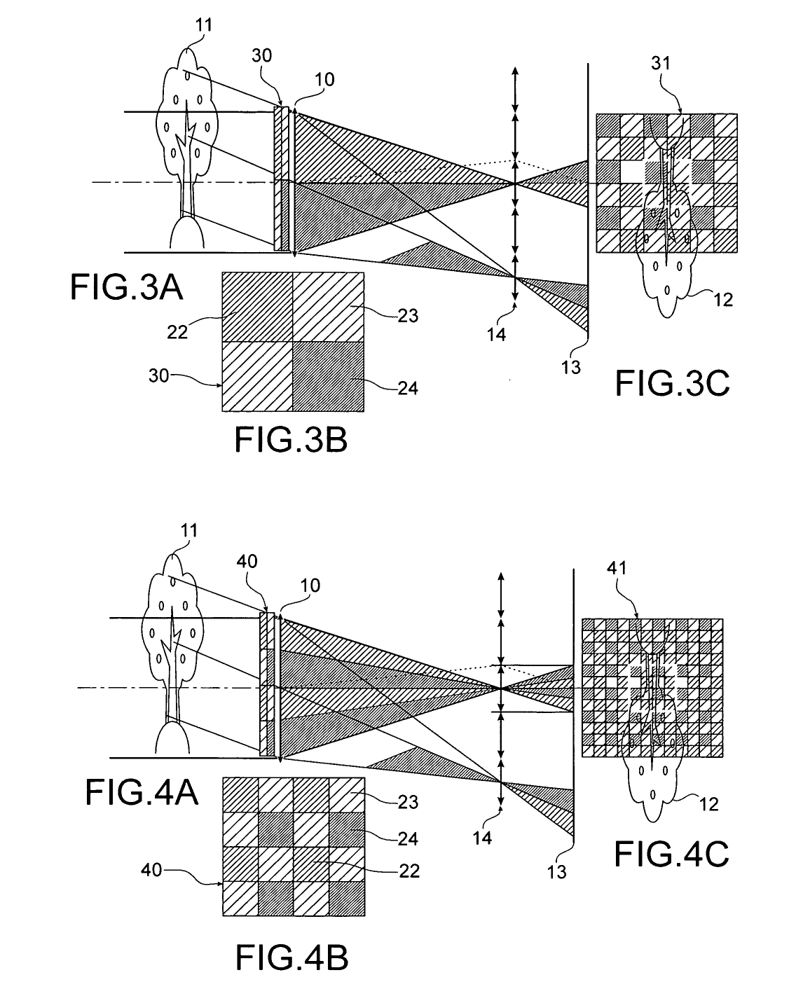

In an alternative embodiment of the device of the invention, shown in FIGS. 4A, 4B and 4C, which correspond respectively to the previous FIGS. 3A, 3B and 3C, a colour filter structure 40 is used, in which, with respect to the colour filter 30, the number of patterns has been increased, thereby making it possible to correspondingly reduce the pitch of the microlenses 14 in order to obtain an image 41 in the plane of the sensor 13.

However, it does not appear to be possible to practically envisage such an approach beyond a pitch twice that of the basic structure of FIG. 3B. Indeed, it must be possible to reach the sensitive zones by one of their edges, by means of metallization tracks that cannot pass in the beams. This is verified when the microlenses 14 are large enough (in the case of the double pitch), insofar as the image 41 of the colour filter 40 is affected little by the diffraction and in which the incident flux can conveniently be localized on each pixel.

It is then advantageous to case the metallizations to “pass around” each group of four pixels, in the “obscure” zones 52 of the image 51 of the filter, as shown in FIG. 5C, with FIGS. 5A and 5B corresponding respectively to FIGS. 3A (4A) and 3B (4B).

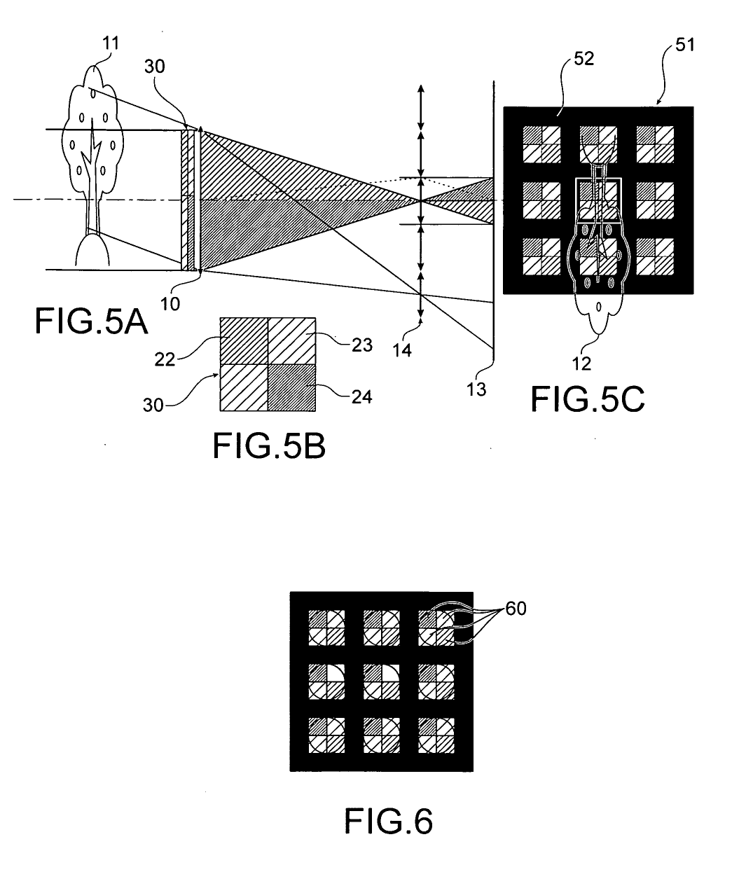

The pupil of the main optics 10 is generally circular, thereby creating images of the coloured filter with a disk shape. The sensitive zones 60 of the sensor can then advantageously have a quarter disk shape, as shown in FIG. 6.

### Example Embodiment

The colour filter structure can be produced on or in the vicinity of an IR (Infrared) filter or an OLPF (Optical Low pass Filter), for example, described in the document referenced [1], used to remove the ripple effect due to the pixel discretisation, in which said filter is arranged near the main optics 10, advantageously in the main optics 10.

The colour filter can be produced by any known conventional optics process, for example by deposition of organic coloured materials, by means of a stencil, on a transparent plate with an optically planar surface. It can also be produced by localized deposits of multiple optical layers functioning by light interference.

In both cases, the colour filter is produced by a collective process, starting with a large substrate (at the base), an IR or OLPF filter on which the photolithographic resin is deposited, which is exposed once through a mask (conventional lithography process) and developed, allowing only the zones intended to receive one of the coloured absorbent materials or the stack of absorbent materials to appear unmasked.

The organic coloured materials can be deposited by “dipping”, a technique that consists of immersing the substrates in a solution of the organic material with a solvent that evaporates after the substrate is removed from the liquid. These organic materials can also be deposited with the whirler as conventionally performed in microelectronics. The dielectric multi-layers, which can include metal layers, are normally produced by PVD (Plasma Vapour Deposition).

Then, the resin remaining after this deposition step is removed (“lift-off” technique), so as to expose the zones of the substrate intended to receive the next filters.

The process is thus repeated as many times as necessary, i.e. three times in the case of a simple Bayer RGB filter.

The colour filter structure can also be arranged on a curved surface of the main optics if it is not far from the position of the pupil.

The microlens array can be formed by an array of one thousand microlenses with a pitch of 1 μm.

### REFERENCES

[1] “Optical low pass filter theory and practice” (application note, Sunex, “optics-online.com/doc/files”.
[2] “CMOS Image Sensors” de Abbas el Gamal et Helmy Eltoukhy (IEEE Circuits & Devices Magazine, May/June 2005.
[3] U.S. Pat. No. 7,070,890.

1. Visible imaging device with a colour filter, including:
main optics (10) equipped with a pupil,
a sensor (13) forming a sensitive pixel array,
a circuit for addressing said pixels,
a microlens array (14) producing the optical conjugation between the pupil of the main optics (10) and a group of pixels of the sensor,
a colour filter (30, 40),
characterised in that the colour filter (30, 40) is arranged in the vicinity of the pupil of the main optics and in that the pitch of the microlenses (14) is twice that of the pixels.

2. Device according to claim 1, wherein the colour filter (30) has a Bayer filter structure with four zones.

3. Device according to claim 1, wherein the colour filter (40) has a structure with twice the pitch of the structure of a Bayer filter with four zones.

4. Device according to claim 1, wherein, in the sensor, the metallizations pass around groups of four pixels.

5. Device according to claim 1, wherein the pupil has a circular shape, and the sensitive zones (60) of the sensor have the shape of disk quadrants.

6. Device according to claim 1, wherein the main optics include an infrared filter or an OLPF on which the colour filter structure is produced.

7. Device according to claim 1, wherein the colour filter is arranged on a curved surface of the main optics (10).
